(19) United States
(12) Patent Application Publication
(10) Pub. No.: US 2002/0164111 A1
(43) Pub. Date: Nov. 7, 2002

(54) MEMS assemblies having moving members and methods of manufacturing the same

(76) Inventor: Amir Raza Mirza, Northville, MI (US)

Correspondence Address: Howard M Gitten, Edwards & Angell, LLP, 600 Corporate Drive, Suite 514, Ft Lauderdale, FL, 33334, US

(21) Appl. No.: 09/848,521

(22) Filed: May 3, 2001

(51) Int. Cl. G02B 6/35

(52) U.S. Cl. 385/18; 359/872; 216/24

(57) ABSTRACT

Methods of manufacturing a MEMS assembly having a shutter or mirror driven by an actuator. The MEMS assembly can be formed by grooving a substrate, forming a displaceable member and electrode actuators on the substrate, and joining to a supporting base. Alternatively, the mirror core and the electrode actuators can be formed on separate substrates and thereafter be joined. A MEMS actuator which moves the member in a direction perpendicular to the MEMS actuator's own plane has interlaced internal ridges. When voltage is applied to the ridges, the actuator's upper and lower substrates move together.

### FIELD OF THE INVENTION

The present invention is directed to a MEMS (micro-electromechanical system) assembly having a movable member or shutter for operating on light as it travels between an input waveguide and at least one output waveguide.

### BACKGROUND OF THE INVENTION

Optical switches are essential components in an optical network for determining and controlling the path along which a light signal propagates.

In such networks an optical signal is guided by a waveguide along an optical path, typically defined by the waveguide core (the terms “light signal” and optical signal” are used interchangeably herein and are intended to be broadly construed and to refer to visible, infrared, ultraviolet light, and the like). It may become necessary or desirable to operate on the optical signal, for example, to redirect the optical signal so that it propagates along a different optical path, i.e., through a different waveguide core.

An exemplary opto MEMS device constructed in accordance with the invention would be an optical switch within a waveguide. With reference now to FIG. 1A, a switch 13 of known construction is depicted which can be used to control the passage of light from a single input optical path 1 to a single output optical path 3. Such a device is known as a 1×1 switch. To form a 1×1 switch, the input optical path 1 and the output optical path 3 optically connect to input waveguide 2 and output waveguide 4, respectively, and the waveguides 2 and 4 are arranged along a common optical axis, with a trench 6 therebetween. A suitably-dimensioned movable shutter 5 is positioned in the trench 6, and is shifted in the direction indicated by arrow A by actuator 7. Light leaving the input waveguide 2 will cross the trench 6 and enter the output waveguide 4, unless the movable shutter 5 is positioned in the trench 6 by actuator 7 on the optical axis. In that case, light leaving the input waveguide 2 will strike the shutter 5 and be prevented from entering the output waveguide 5. This explanation of a 1×1 switch is by way of illustration only, and not limitation.

By way of further example, as depicted in FIG. 1B, a 1×2 switch 15 can be used to direct light from an input optical path 1 to either of two different output optical paths, 3 and 11. Input optical path 1 optically connects to an input waveguide 2, while output optical paths 3 and 11 connect to output waveguides 4a and 4b, respectively. The input waveguide 2 and output waveguide 4a are arranged along a common optical axis, meaning that light can travel from the input waveguide 2 to the output waveguide 4a unless blocked. A suitably-dimensioned movable mirror 8 is positioned in a trench 6, and can be shifted in the direction of arrow A by actuator 7. The trench 6 and movable mirror 8 are arranged at an angle such that when the movable mirror 8 does not lie on the optical axis, light leaving the input waveguide 2 crosses the trench 6 and enters the output waveguide 4a. When the movable mirror 8 is positioned in the trench 6 on the optical axis, light leaving the input waveguide 2 will strike the mirror 8 and be reflected into output waveguide 4b, rather than output waveguide 4a. Again, this arrangement is for illustration only, and not limitation.

It should be noted that both the 1×1 switch 9 and the 1×2 switch 15 are planar devices in which the actuator 7, shutter 5 or mirror 8, and the input and output waveguides 2, 4, 4a, 4b all lie in the same plane. Because of this arrangement, the shutter 5 and mirror 8 are moved along lines which lie in the same plane as the optical waveguides. This means that the trench 6 must be long enough to allow the shutter 5/mirror 8 to move into and out of position before the input waveguide 2. Consequently, a switch of this type may be substantially larger than the shutter 5 or mirror 8 used therein.

Size is an ever-present concern in the design, fabrication, and construction of optical components (i.e., devices, circuits, and systems). It is clearly desirable to provide smaller optical components so that optical devices, circuits, and systems may be fabricated more densely, consume less power, and operate more efficiently. Reducing the size of moving elements of an optical component such as the switches just described also may beneficially increase the optical component's response time.

Presently, switches for use with optical waveguides can be fabricated using conventional integrated circuit (IC) patterning techniques. According to these techniques, the mirror and actuator beams are formed on the same surface of a support. Switches having mirrors and beams made in this manner are bulkier, heavier, and have slower operating speeds than is desirable.

Transmission of an optical signal from one waveguide to another may require that the optical signal propagate through a medium which may have an index of refraction different than the index of refraction of the waveguides (which typically have approximately the same refractive index). It is known that the transmission characteristics of an optical signal may be caused to change if that signal passes through materials (media) having different indices of refraction. For example, an unintended phase shift may be introduced into an optical signal passing from a material having a first index of refraction to a material having a second index of refraction due to the difference in velocity of the signal as it propagates through the respective materials and due, at least in part, to the materials' respective refractive indices. Additionally, a reflected signal may be produced due to the mismatch of polarization fields at the interface between the two mediums. As used herein, the term “medium” is intended to be broadly construed and to include a vacuum.

This reflection of the optical signal is undesirable because it reduces the transmitted power by the amount of the reflected signal, and so causes a loss in the transmitted signal. In addition, the reflected signal may travel back in the direction of the optical source, which is also known as optical return loss. Optical return loss is highly undesirable, since it can destabilize the optical signal source.

If two materials (or mediums) have approximately the same index of refraction, there is no significant change in the transmission characteristics of an optical signal as it passes from one material to the other. One solution to the mismatch of refractive indices involves the use of an index matching fluid. A typical use in an optical switch is to fill a trench between at least two waveguides with a material having an index of refraction approximately equal to that of the waveguides. Thus, the optical signal does not experience any significant change in the index of refraction as it passes through the trench from one waveguide to another.

An example of that solution may be found in international patent application number WO 00/25160. That application describes a switch that uses a collimation matching fluid in the chamber between the light paths (i.e., between waveguides) to maintain the switch's optical performance. The use of an index matching fluid introduces a new set of considerations, including the possibility of leakage and a possible decrease in switch response time due to the drag on movement of the switching element in a fluid.

In addition, the optical signal will experience insertion loss as it passes across a trench and between waveguides. A still further concern is optical return loss caused by the discontinuity at the waveguide input/output facets and the trench. In general, as an optical signal passes through the trench, propagating along a propagation direction, it will encounter an input facet of a waveguide which, due to physical characteristics of that facet (e.g., reflectivity, verticality, waveguide material, etc.) may cause a reflection of part (in terms of optical power) of the optical signal to be directed back across the trench (i.e., an a direction opposite of the propagation direction). This is clearly undesirable.

Given the aforementioned ways in which an optical signal passing through a switch can be distorted, there is a need for switches in which such distortion is eliminated or at least reduced. The present invention takes advantage of the discovery that one way by which this can be done is to reduce the size of the trench and mirror/shutter used in the switch, since that will reduce the distance the optical signal must travel outside of a waveguide.

FIG. 1C is an exemplary view of a thermal actuator which can be used to shift a mirror or shutter 5. The mirror or shutter 5 is mounted on a base 10, and that base 10 is connected via a linkage 14 to a beam 15. It is also possible that the link 14 could be a part of either the base 10 or the beam 15. Beam 15 is can be v-shaped, and is joined at its ends to fixtures 16A and 16B. Fixtures 16A and 16B serve to hold the ends of the beam 15 at the same position. When voltage is applied to the fixtures 16A and 16B, as shown in FIG. 1D, the current flowing through the beam 15 will cause resistive heating, with attendant expansion of the beam 15. Expansion and the subsequent contraction of the beam as it cools will cause the mirror or shutter 5 mounted on base 10 to reciprocate in the direction of arrow A.

FIG. 1E is an exemplary view of an electrostatic actuator which can be used to a mirror or shutter 5. The mirror or shutter 5 is mounted on a base 10, and that base 10 is connected via a linkage 14 to a beam 26. It is also possible that the link 14 could be a part of either the base 10 or the beam 26. Beam 26 is itself connected via arms 18 and 24 to immobile anchors 22. One or more projections 20 extend from beam 26; as depicted in FIGS. 1E and 1F, the projections 20 give the beam a comb-like appearance. These projections 20 interlace with corresponding projections 19, which extend in like manner from base 17. When, as shown in FIG. 1F, electric potential is applied to the base 17, the resulting charge difference will, as applied and removed, cause the projections 19 and 20 to be attracted to one another, so that mirror or shutter 5 is moved in the direction of arrow A. Although arms 18 and 24 are joined at one to immobile anchors 22, those arms will deform elastically, so that the projections 20 can be drawn toward projections 19. When the potential is no longer applied, this elastic deformation will cause the beam 26 to shift back to the position depicted in FIG. 1E.

In summary, there is a long-felt need for optical switches which are compact and which operate quickly.

### SUMMARY OF THE INVENTION

The present invention is directed to the manufacture of a MEMS assembly having a movable member. In such a MEMS assembly the member can be moved in a direction generally perpendicular to the plane in which the optical signal travels. This means that switches, for example, made with this MEMS assembly can be made more compactly than known 1×1 and 1×2 switches, which as already noted are planar devices. Both 1×2 and 2×2 optical switches can be constructed in accordance with this invention.

By way of example, the MEMS assembly having a mirror and actuator can be formed by grooving a first substrate to define electrode actuators and a central mass therebetween which remain attached to a portion of the first substrate, joining the first substrate to a second substrate having a recess, forming a displaceable member on the first substrate, and freeing the plural electrode actuators and the central mass by removing the portion of the first substrate to which they are attached. Optionally, metallization can be applied to the member to form a mirror.

Additionally, a MEMS assembly having a displaceable member and an actuator can be formed by diffusing impurities into the surface of a first substrate to form a diffusion layer, grooving the diffusion layer to define portions corresponding to electrode actuators and the displaceable member therebetween, filling at least some of the grooves with spacer material, forming a second groove in the portion of the diffusion layer corresponding to the displaceable member which extends through the thickness of the diffusion layer to expose a region of the underlying first substrate, and diffusing impurities into at least part of the exposed region of the first substrate to form a diffusion region. The spacer material is removed from the first grooves to free the electrode actuators and the displaceable member. Again, metallization can be applied to at least the movable member to form a mirror body.

A MEMS assembly with a mirror and actuator also can be made from a first substrate and a second substrate having a layer of oxide sandwiched between an upper layer and a lower layer by diffusing impurities into the surface of the first substrate to form a first diffusion region, forming a groove in the first diffusion region which extends through the diffusion region to expose the first substrate lying beneath, and diffusing impurities into the first substrate exposed by the groove to form a second diffusion region, the first and second diffusion regions together forming a displaceable member. The upper layer of the second substrate is grooved to define electrode actuators which remain attached to part of the oxide layer, and at least some of the grooves and upper layer are covered with a covering oxide layer. The substrates are placed together so that the first diffusion region contacts part of the covering oxide layer, and some of the covering oxide layer, including the oxide layer filling the grooves, is removed to expose at least some of the oxide layer remaining beneath and supporting the first diffusion region. The electrode actuators are freed. If desired, metallization can be applied to at least part of the displaceable member to form a mirror body.

Another way to manufacture a MEMS assembly involves providing a first substrate having a displaceable member lying in a plane which is not parallel to a plane of the first substrate and a second substrate having a layer of oxide sandwiched between an upper layer and a lower layer. The upper layer of the second substrate is grooved with grooves to define electrode actuators which remain attached to a portion of the oxide layer. As least some of the grooves and covering at least some of the upper layer with a covering oxide layer are filled. The first and second substrates are brought together so that the displaceable member core contacts part of the covering oxide layer, and all of the first substrate save for the displaceable member and some of the covering oxide layer, including the oxide layer filling the grooves, is removed. At least some of the oxide layer remains beneath and supports the first diffusion region, and the plural electrode actuators are freed. Metallization can be applied to at least part of the displaceable member to form a mirror.

The present invention is also directed to high-precision methods for manufacturing MEMS assemblies. For instance, a MEMS assembly can have a generally planar silicon base with ridges extending therefrom, a generally planar covering silicon diaphragm joined to the silicon base, having a rim portion at least partially enclosing a roof portion, and ridges extending from the roof portion, these ridges interlace with at least some of the ridges of the silicon base. A MEMS member is positioned atop the roof portion of the silicon diaphragm, and when electrical potential is applied to the silicon base and the silicon diaphragm, the silicon base and the silicon diaphragm move toward one another.

The invention accordingly comprises the features of construction, combination of elements, and arrangement of parts which will be exemplified in the disclosure herein. The scope of the invention will be indicated in the claims.

### BRIEF DESCRIPTION OF THE DRAWINGS

In the drawing figures, which are not to scale, and which are merely illustrative, and wherein like reference characters denote similar elements throughout the several views:

FIGS. 1A and 1B are top plan views of two different known optical switch arrangements, FIGS. 1C and 1D are top plan views of a known thermal actuator construction in two different states, and FIGS. 1E and 1F are top plan views depicting an electrostatic actuator in two different states.

FIGS. 2A to 2G are side cross-sectional views showing the construction of a first embodiment of a MEMS assembly in accordance with the present invention;

FIGS. 3A to 3C are side cross-sectional views depicting the construction of a second embodiment of a MEMS assembly according to the present invention; FIGS. 4A to 4E are side cross-sectional views showing the construction of a third embodiment of a MEMS assembly constructed according to the present invention;

FIGS. 5A to 5H are side cross-sectional views showing the construction of a fourth embodiment of a MEMS assembly in accordance with the present invention;

FIGS. 6A to 6F are side cross-sectional views showing the fabrication of a fifth embodiment of a MEMS assembly pursuant to the present invention;

FIGS. 7A to 7E are side cross-sectional views showing the construction of a sixth embodiment of a MEMS assembly constructed in accordance with the present invention; and

FIGS. 8A and 8B are perspective views showing the construction of a seventh embodiment of a MEMS assembly in accordance with the present invention.

### DETAILED DESCRIPTION OF THE PRESENTLY PREFERRED EMBODIMENTS

One aspect of the present invention involves a movable member for operating on light as it traverses between an input waveguide and one or more output waveguides, the input and at least one output waveguide being separated by and disposed around a trench. The input and output waveguides have respective optical paths defined by their respective cores, and the trench has a medium provided therein with a refractive index different from that of the waveguides. The input waveguide and output waveguide(s) are separated by a distance insufficient to affect the transmission characteristics of an optical signal propagating from the input waveguide to the output waveguide(s), even though the optical signal experiences different refractive indices as it propagates from the input waveguide to the output waveguide(s). Passage of light from the input waveguide to the output waveguide(s) is regulated by either a movable MEMS (micro-electromechanical system) member such as a mirror, chopper, filter attenuator or shutter which can be shifted in a direction not parallel to, and preferably, perpendicular to, the plane in which the waveguides and trench lie.

More particularly, the present invention is directed to the arrangement and fabrication of a MEMS member and an actuator for moving that member. Taken together, the MEMS member and actuator are referred to herein as a“MEMS assembly”. For simplicity of explanation, but not in a limiting sense, the embodiments described below are described in terms of a mirror or shutter, but it is understood that other actuatable members such as a chopper, attenuator filter and the like can be substituted for the mirror or shutter. Those skilled in the art will appreciate that the use of the term mirror in connection with various embodiments of this invention may also encompass use of a shutter, just as use of the term shutter may encompass use of a mirror. Moreover, the other actuatable optical components could be used instead.

Moreover, while the following embodiments are described with reference to optical waveguides, this invention need not be limited thereto. This invention also may be applied to optical fibers, and to the free-space propagation of light.

By way of overview, this invention provides a MEMS mirror suitable for use in a 1×1, 1×2 or 1×N switch (N being an integer greater than 2), together with supporting and actuating structure. This is accomplished by shaping and thereafter joining together upper and lower substrates to form a workpiece. The workpiece then undergoes final processing to produce a MEMS assembly having a mirror (or shutter). The MEMS assembly is itself incorporated into a switch, where the MEMS assembly serves to control the passage of optical signals from an input waveguide to one or more output waveguides.

First Embodiment

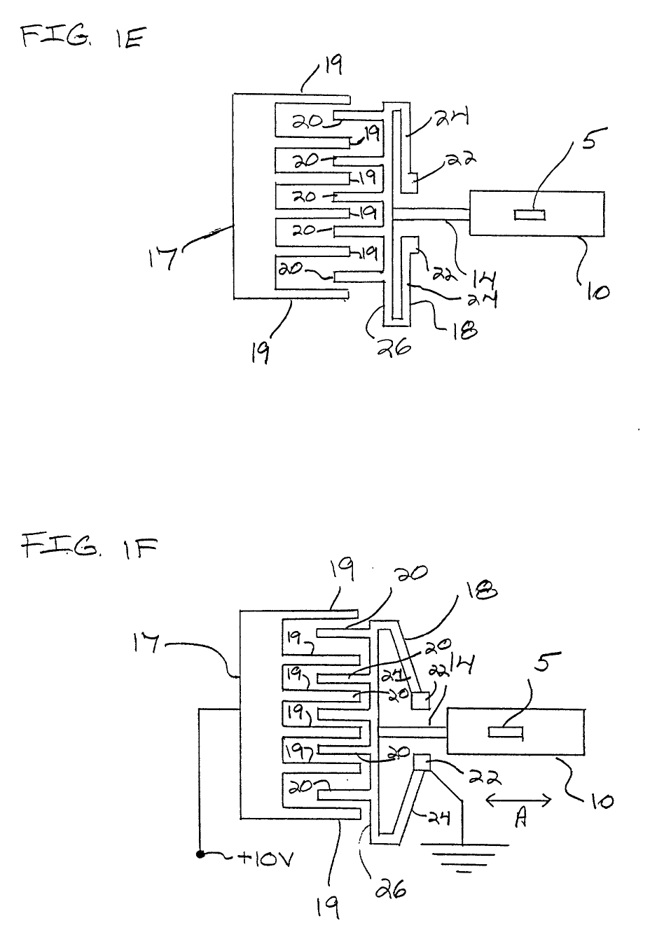

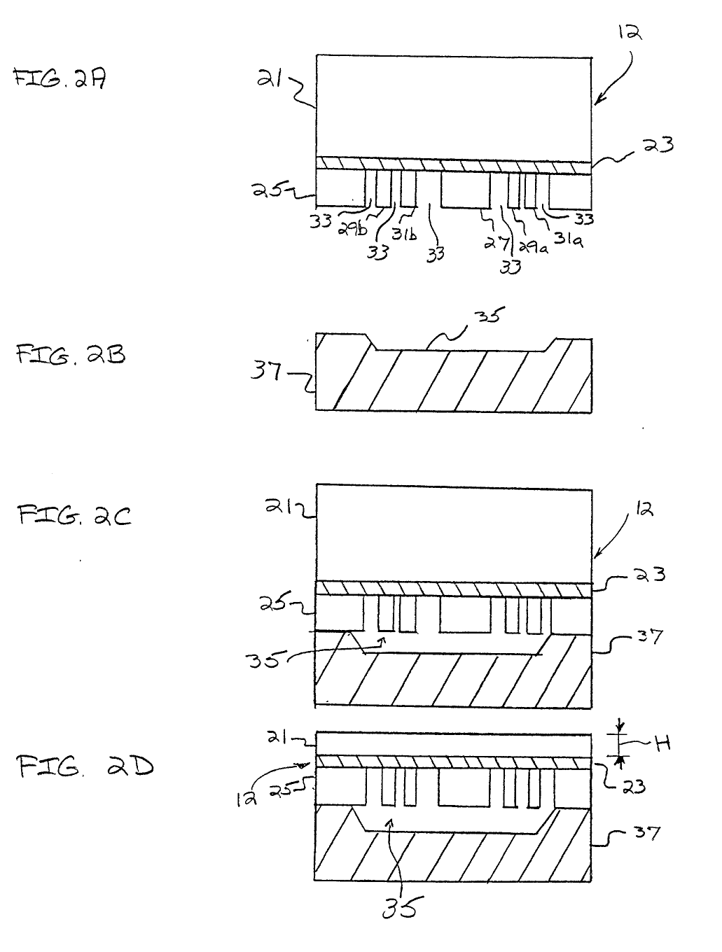

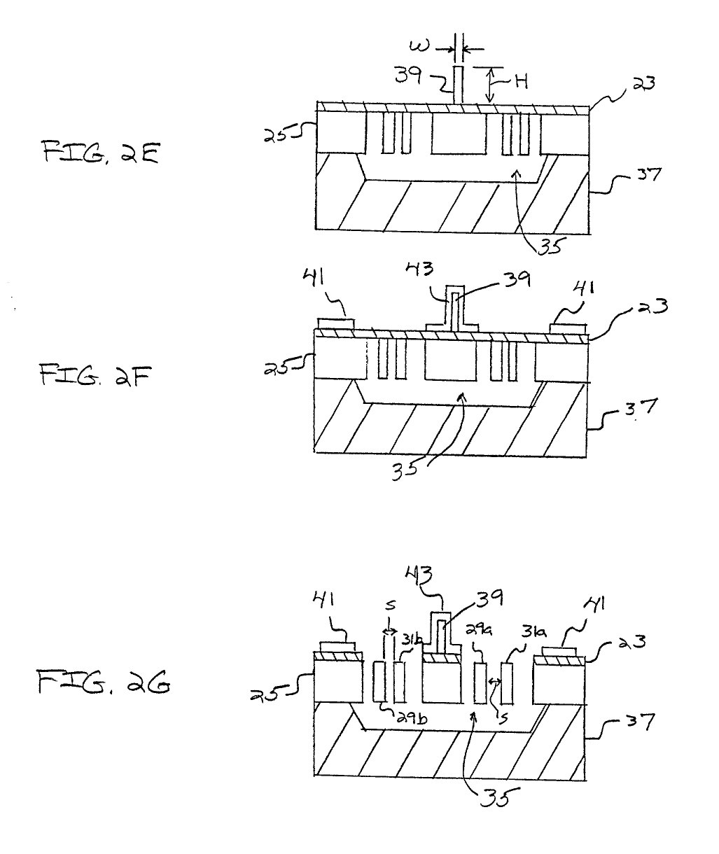

Now, with reference to FIGS. 2A-2G, and by way of non-limiting example, one example of a MEMS assembly constructed in accordance with the present invention will be discussed.

The relative terms “upper” and “lower”, incidentally, will be used by way of example only and not limitation. It will be understood that this and other embodiments of the invention could be manufactured with the substrates in alternative orientations, such as arrangements rotated by 90° or 180° from that depicted in FIGS. 2A-2G.

With reference now to FIG. 2A, the upper substrate 12 is a multilayer member consisting of a relatively thick uppermost layer 21 of Si, for example, about 500 μm thick, overlying a layer 23 of SiO₂ approximately 1 μm thick. The SiO₂ oxide layer 23 in turn overlies a Si lower layer 25 that can be about 20 μm thick. The uppermost layer 21 of Si preferably has a crystallographic orientation of <110> if the mirror is to be formed by wet etching, and <100> if the mirror is formed by plasma etching. These dimensions and arrangements are by way of example only, and not limitation. Likewise, other materials could be used, for example, Si₃N₄ could be used in place of the SiO₂ layer.

The layered Si—SiO₂—Si wafer could be a SOI (silicon-on-insulator) wafer. Such wafers are known and commercially available. SOI wafers can be formed by taking two silicon wafers, grinding and polishing one or both to the desired thickness, oxidizing one of the faces of each, and then bringing the oxidized faces together so that they fuse.

Alternatively, the upper substrate 12 can be formed by taking a Si substrate some 500 μm thick, and oxidizing one surface of that Si substrate to a depth of approximately 1 μm. Oxidizing can be effected by placing the Si substrate into a chamber with the surface to bear the oxide layer exposed, raising the temperature therein, and introducing a suitable oxidizing agent such as O₂ to oxidize the exposed surface of the Si substrate to form the oxide layer 23. Then, a lower Si layer 25 approximately 500 μm thick is formed on the free side of the oxide layer 23. The lower Si layer can be formed using any suitable known technique, such as sputtering.

As will be explained in greater detail hereafter, the oxide layer 23 sandwiched between the two Si layers 21, 25 will serve as an etch stop while the upper substrate 12 is shaped. Because Si has a much higher etching rate than SiO₂, etching of Si layer 25 effectively stops when the overlying SiO₂ layer 23 is exposed. This etch stop layer 23 improves the precision with which the actuator and mirror components of the MEMS assembly are made, as will be explained hereafter.

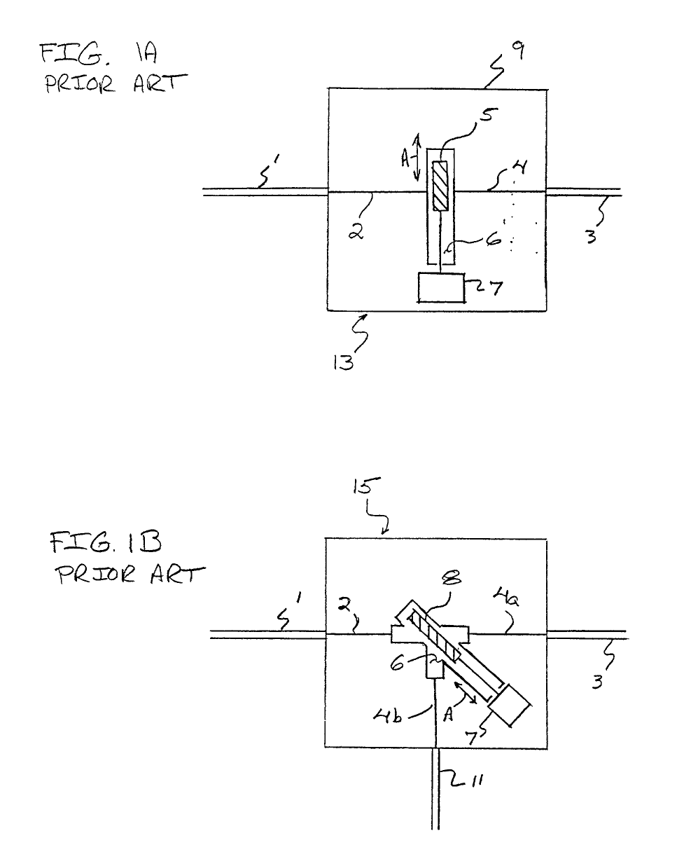

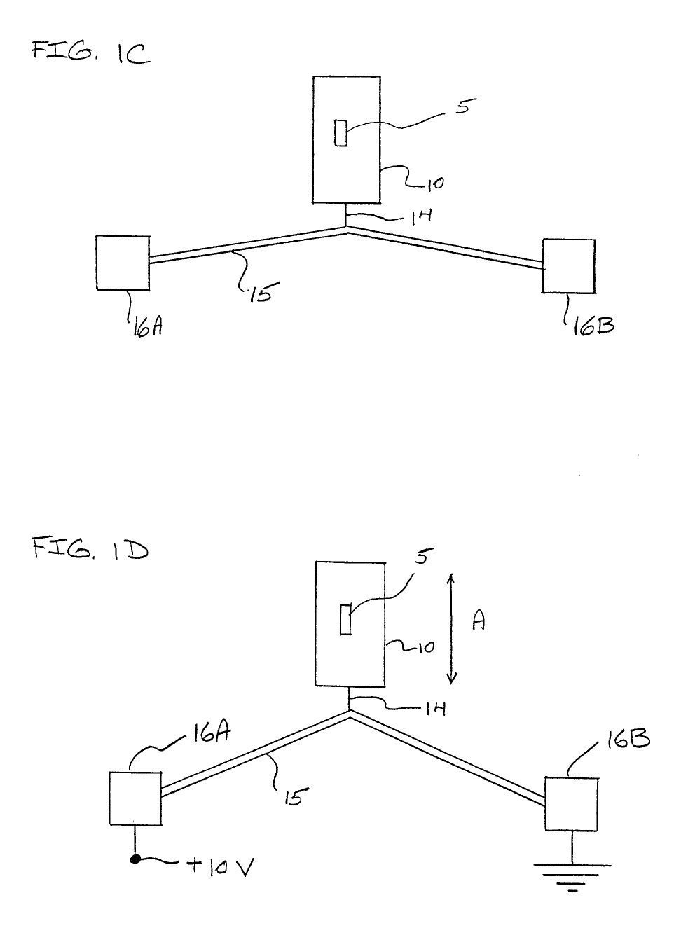

With continued reference to FIG. 2A, the lower Si layer 25 has several grooves 33 formed therein. These grooves 33 define portions 29a, 29b, 31a, 31b of the lower Si layer 25 which will later become actuator movable arms and a central mass 27 which will later support the mirror (or shutter). The term “actuator movable arms” (or “actuator arms”) refers generally to the portions of the device corresponding to projections 19 and 20 shown in FIGS. 1E and 1F, and beam 15 shown in FIGS. 1C and 1D. The grooves 33 can be formed using suitable known technique such as deep RIE (reactive ion etching) plasma etching of the Si layer, or any other suitable techniques which may be invented hereafter, to etch from the surface of the lower Si layer 25 inward toward the sandwiched SiO₂ layer 23. As already noted, the sandwiched SiO₂ layer 23 is an etch stop layer, meaning that once it is exposed etching effectively ends. The oxide layer 23 thereby repeatably defines the height of the actuator movable arms 29a, 29b, 31a, 31b and the central mass 27 and, at the same time, prevents the adjoining upper Si layer 21 from being etched. Additionally, the SiO₂ layer 23 secures the actuator arms 29a, 29b, 31a, 31b and the central mass 27 in place.

Preferably, the grooves 33 formed in the lower Si layer 25 are less than 2 μm in width, the actuator movable arms 29a, 29b, 31a, 31b are approximately 3 μm wide, and the central mass 27 is about 100 μm wide. Advantageously, the portions of the lower Si layer 25 corresponding to the actuator movable arms 29a, 29b, 31a, 31b and the central mass 27 remain secured to the adjoining SiO₂ layer 23, which thereby stabilizes those components during the fabrication process.

With reference now to FIG. 2B, a central recess portion 35 is formed in a lower substrate 37 made from a Pyrex® or silicon wafer. By way of non-limiting example, a Si wafer 500 μm thick can serve as the lower substrate 37. The wafer is in known manner coated with photoresist material and patterned by exposure to radiation to cure portions of the photoresist in a pattern corresponding to the desired shape of the recess 35. Thereafter, the coated substrate is etched in known manner, removing, to the desired depth, those portions of the substrate material not protected by the cured photo resist, thereby forming the recess 35. While wet etching is presently preferred, other techniques such as ultrasonic etching, EDM processing, or any other suitable technique, whether now known or hereafter invented, also could be used.

Although the lower substrate 37 as shown in FIG. 2B is made from a single layer of material, a multilayer substrate also could be used.

The upper and lower substrates 12, 37 are then joined together, as depicted in FIG. 2C. This can be done by bringing the two substrates 12, 37 into contact as shown and then anodically bonding the upper substrate 12 to the lower substrate 37. Also by way of non-limiting example, the two substrates 12, 27 could be joined by forming a lower temperature glass frit seal therebetween (not shown), or by silicon direct bonding, also known as fusion bonding. Any other suitable joining techniques, whether now known or hereafter developed, also could be used to attach substrates 12, 27.

With continued reference to FIG. 2C, it should be noted that the recess 35 formed in the lower substrate 37 provides clearance between that substrate 37 and the actuator movable arms 29a, 29b, 31a, 31b and central mass 37 formed in the upper substrate 12. The recess also is provided for heat transfer purposes; in the case of a thermal actuator, heat from the thermal actuator will not enter as readily into the substrate. Any suitable depth recess could be used, and it is presently envisioned that the recess be between 50-200 μm in depth.

As shown in FIG. 2D, the assembled upper and lower substrates 12, 37 are processed to thin the upper Si layer 21. The upper Si layer 21 is reduced in height to the desired mirror or shutter height H; by way of non-limiting example this can be done using known techniques such as wet etching with KOH, NaOH, TMAH, EDP or hydrazine, or grinding and polishing.

With reference now to FIG. 2E, after the upper Si layer 21 has been uniformly thinned, all of Si layer 21 is removed, save for the portion which forms the mirror core 39 (or shutter). By way of non-limiting example, the mirror core 39 can have a height H of approximately 40 μm and have a width W of approximately 3 μm. It will be appreciated that this is a high aspect ratio structure (lower aspect ratios also could be used). Selective removal of the upper Si layer 21 can be effected by known techniques such as anisotropic wet etching or deep reactive ion etching (“RIE”). As part of the RIE processing, the surface of the upper Si layer 21 is masked and photoexposed to protect the portion which becomes the mirror core (shutter) 39, in known fashion.

After the mirror core 39 has been formed, Au/Cr metallization is applied to the mirror core 39 and oxide layer 23 as shown in FIG. 2F to form the reflective mirror coating 43 and bond pads 41, to which electrical leads supplying the power to operate the MEMS assembly will later be attached. Au/Cr refers to the technique of forming gold atop chromium, which is done because an intermediate adhesion layer is needed when joining gold to silicon. By way of non-limiting example, the applied metallization can be 1 μm thick. The metallization can be applied in known manner, for example, by first applying the metallization layer using sputtering, thereafter applying a protective photosensitive coating thereon, masking and exposing the photosensitive coating to define which portions of the metallization will be removed, and then using a suitable agent to remove the non-exposed portions of the protective coating and the metallization therebeneath. For non-mirrored MEMS assemblies, further processing other than metallization can be performed. For example, in a chopper, vertical etching would be performed, in the case of a filter, a different type of coating would be performed.

Finally, the central mass 27 and the actuator movable arms 29a, 29b, 31a, 31b attached to the oxide layer 23 are released by removing the oxide layer 23, yielding the final wafer stack shown in FIG. 2G. The oxide layer 23 can be removed in known manner by wet or dry etching under suitable reaction conditions, such as with hydrofluoric acid (HF) and dry plasma etching.

Depending upon the spacing of the actuator movable arms 29a, 29b, 31a, 31b the resulting structure will operate by electrostatic or electrothermal driving. If the electrodes spacing S is approximately 2 μm the MEMS assembly will operate electrostatically, while if the electrode spacing S is approximately 6 μm, the MEMS assembly will operate electrothermally. In the case of an electrothermal actuator, ganged beams connected together at their apexes could be provided to increase the force which can be applied. The gap for such an arrangement could be approximately 8 μm.

A further benefit to the foregoing construction is that the production techniques used to manufacture the MEMS assembly can be scaled up to wafer level. This means that multiple MEMS actuated mirrors and/or shutters of the type just described can be formed on a single chip.

The final wafer stack can be bonded at the wafer level to another wafer (not shown) containing thin film optical waveguides, such as silica waveguides (MEMS assemblies also could be attached to devices or wafers on an individual basis). Joining the wafer stack to the wafer having the waveguides on a wafer basis reduces significantly packaging requirements for mixed MEMS/silica waveguide devices. Additionally, significant reductions in the time required and the costs of aligning the mirrors and the waveguides can be realized, since the mirrors and waveguides are aligned simultaneously as the wafers are aligned.

Unlike known MEMS devices, the present invention provides the actuator components and the mirror (or shutter) on opposite sides of an SOI wafer. This is beneficial in part because fabrication of the actuator electrodes is not compromised, in terms of quality, by fabrication processes carried out to form the mirror and its underlying structure.

Manufacturing MEMS assemblies as described above also allows for tight control of the dimensions of the actuators which are formed. In particular, tight manufacturing tolerances can be achieved because the actuator arms are produced as a result of the bulk doping of the SOI active layer, which doping can be performed with precision. Additionally, the thickness of the actuator beams is determined by the thickness of the SOI active layer itself, which can be controlled to within ±1 μm. Furthermore, the width of the actuators can be repeated with sub-micron accuracy, because the procedures used to form those actuator arms, the photoresist process and deep RIE etching, have micron to sub-micron manufacturing tolerances themselves.

Second Embodiment

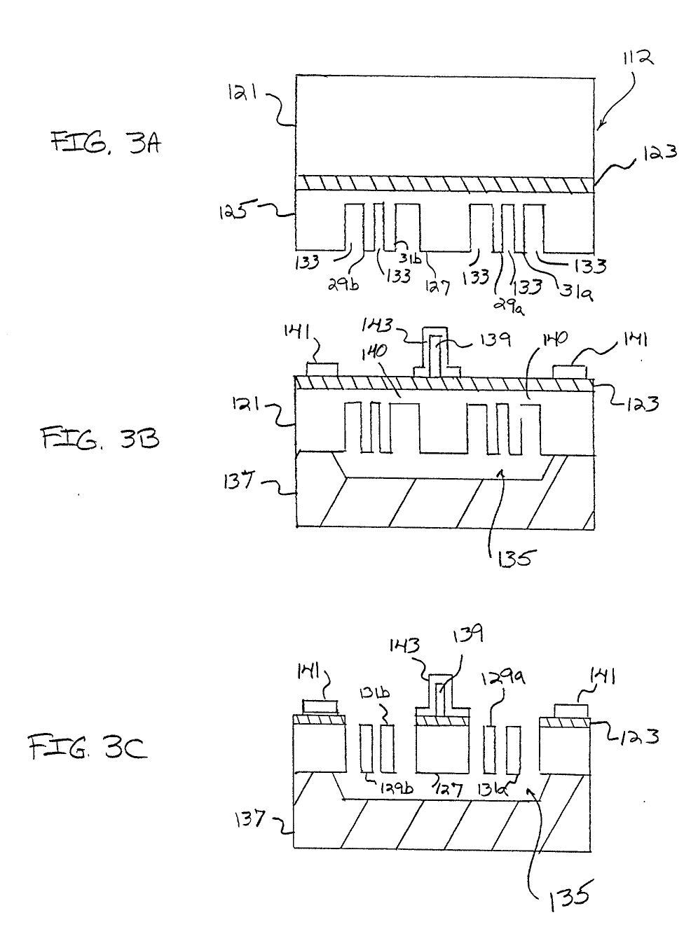

This embodiment is a refinement of certain aspects of the first embodiment already described with reference to FIGS. 2A-2G. As shown in FIGS. 3A and 3B, the grooves 133 formed in the lower layer 121 of the upper substrate 112 do not fully extend through the thickness of that lower layer. This embodiment therefore differs from the first embodiment of the invention in that the RIE etching which forms the grooves 133 in lower layer 121 is terminated before the underlying SiO₂ etch stop layer 123 is exposed. This way, some of the Si material remains at the bottom of each groove 133. By way of non-limiting example, about 1 μm of Si remains at the bottom of each of the grooves 133 in the lower layer 121. Leaving some Si at the bottom of each of the grooves 133 strengthens the upper substrate 112 both before and after it is joined to the lower substrate 137 to a greater extent than if only the SiO₂ layer was present. Such stiffening is beneficial because it improves the handling and robustness of the MEMS assembly.

Because the actuator movable arms 129a, 129b, 131a, 131b and the central mass 127 are joined to the approximately 1 μm thick remaining layer of Si, freeing those arms 129a, 129b, 131a, 131b and mass 127 can be performed first by wet or dry etching to remove the oxide layer 123, followed by dry etching of the 1 μm silicon layer to free those components. Once freed, the actuator movable arms 129a, 129b, 131a, 131b and the central mass 127 can move in their intended manner.

This manner of manufacturing MEMS assemblies is tolerant of under- and over-etching of the silicon layer 125. By way of non-limiting example, the layer of silicon remaining beneath the grooves 133 in the lower layer 125 of the upper substrate 112 could be between approximately 0.3-1.3 μm in thickness. This reduces the manufacturing tolerances for the groove-forming procedure, while still providing a stiffening support structure able to tolerate compressive stresses in the oxide layer 123 which may be generated during manufacturing.

In all other respects this embodiment is generally similar to the first embodiment of the invention.

Third Embodiment

The next embodiment of this invention will be described with reference to FIGS. 4A-4E. This embodiment simplifies manufacture of a MEMS assembly and lowers manufacturing cost by substituting an inexpensive silicon wafer for the substantially more expensive SOI wafer previously described.

As shown in FIG. 4A, upper substrate 201 is made from a single Si wafer, rather than being a multiple-layer substrate such as those described in connection with previous embodiments. Instead, the upper substrate 201 can be made by machining a standard Si wafer using known procedures. By way of non-limiting example, a standard Si wafer could be shaped in known manner using a photoresist process and RIE silicon etch process to form on one side of the upper substrate 201, shown in FIG. 4A as the lower side, grooves 233 each approximately 20 μm deep. These grooves 233 will define the actuator movable arms 229a, 229b, 231a, 23b and the central mass 227.

It should be noted that as shown in FIG. 4D, the actuator movable arms 229a, 229b, 231a, 23b and the central mass 227 remain joined to a residual portion 240 of the Si upper substrate 201 some 1-2 μm thick. Preferably, this residual portion 240 is thick enough to provide the upper substrate 201 with sufficient thickness to avoid unwanted flexing during the manufacturing process.

With reference to FIG. 4C, the grooved upper substrate 201 is attached to a lower substrate 237 having a shallow recess 235 therein. The lower substrate 237 can be prepared by etching a shallow recess 235 in a Pyrex® or silicon wafer substrate in the manner which already has been described in connection with other embodiments of this invention.

The upper and lower substrates 201, 237 can be joined together by anodic (electrostatic) bonding of the upper substrate 201 to the lower substrate 237, or by using low temperature glass frit (not shown) or silicon direct bonding to connect the substrates 201, 237. Again, this can be done in generally the same manner as has already been discussed in connection with the first embodiment of this invention.

Once the two substrates 201, 237 are joined together the upper substrate 201 is shaped to form the mirror core 239. This can be done, by way of non-limiting example, using photoresist processing with anisotropic wet etching or deep RIE etching, again, in the same manner as already has been described in connection with the previous embodiments of this invention.

Next, as shown in FIG. 4E, metallization is applied to the upper substrate 201 in the same manner as has already been described for previous embodiments of this invention to form the mirror's surface 243, and, if desired, bond pads 241.

As already noted, a residual portion 240 of Si material some 1-2 μm thick remains at the end of the grooves 233 and joins the actuator movable arms 229a, 229b, 231a, 231b and the central mass 227. To free the actuator movable arms 229a, 229b, 231a, 231b and the central mass 227, the residual portion 240 can be removed by performing a short, shallow silicon dry plasma etch, for example. Other techniques for removing the residual material 240 also could be used, whether now known or hereafter developed.

Among the benefits of this approach to forming the MEMS assembly is that manufacturing costs can be reduced, in part owing to the use of a solid Si wafer in place of a layered SOI wafer for the upper substrate. This embodiment also offers the benefit of a stiff upper substrate, similar to the second embodiment, by virtue of the 1-2 μm of silicon left by grooves 233 which joins the actuator movable arms 229a, 229b, 231a, 231b and the central mass 227. Additionally, the dimensions of the different Si components can be controlled precisely, even without the use of an etch stop layer, since those components are made using precise etching procedures wherein manufacturing tolerances are a function of the masking process used therein, rather than the etching itself.

Fourth Embodiment

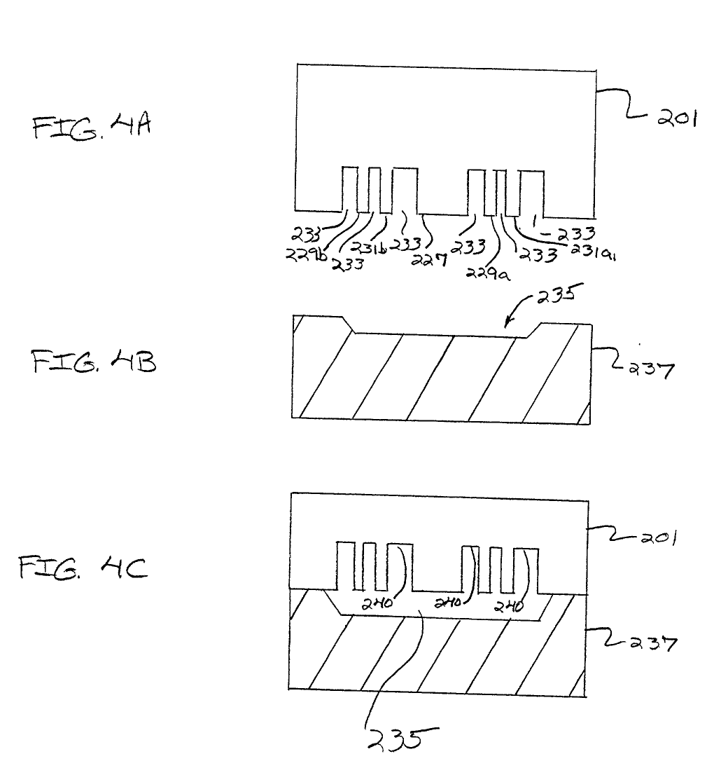

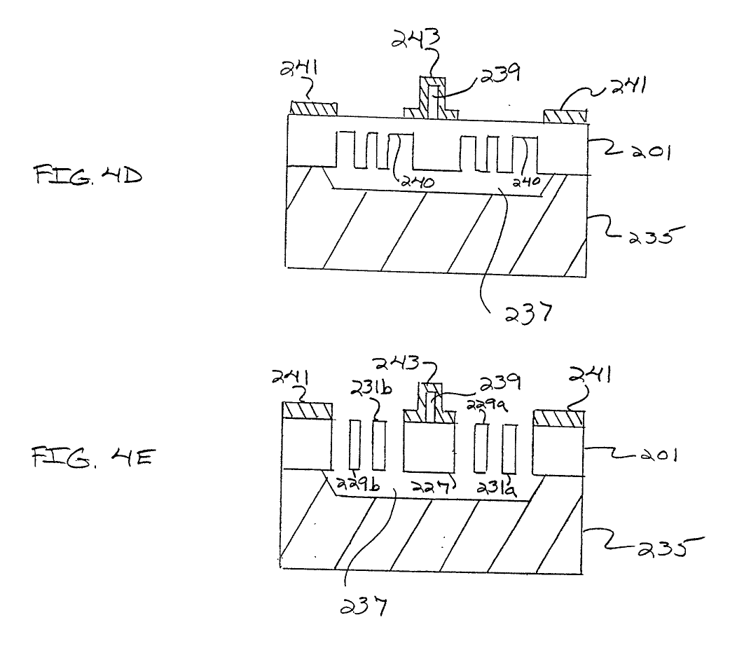

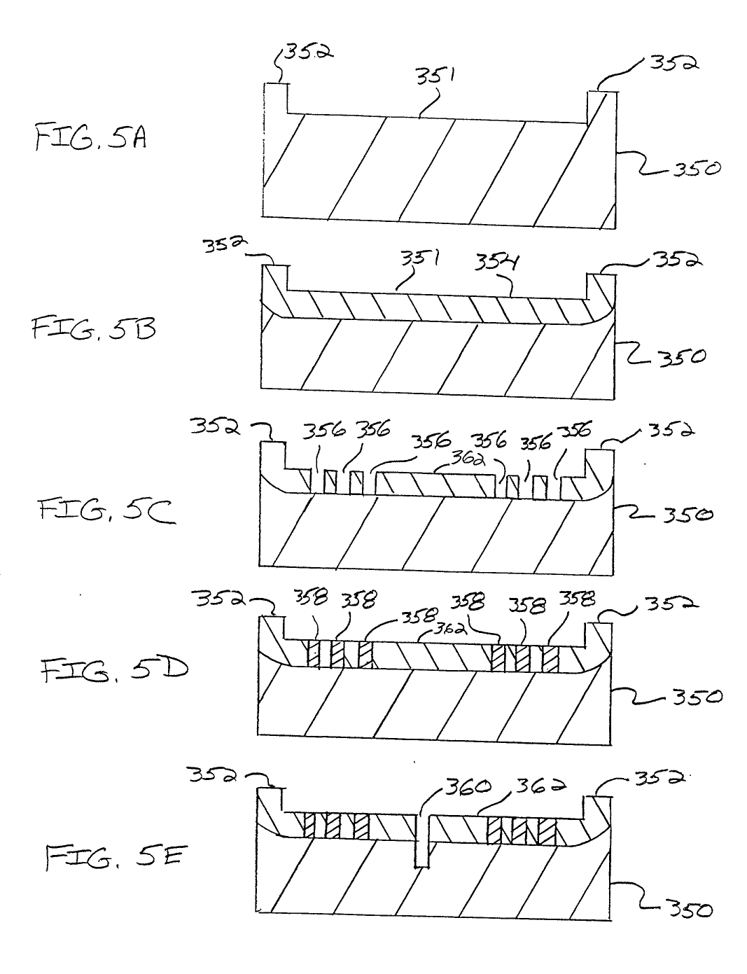

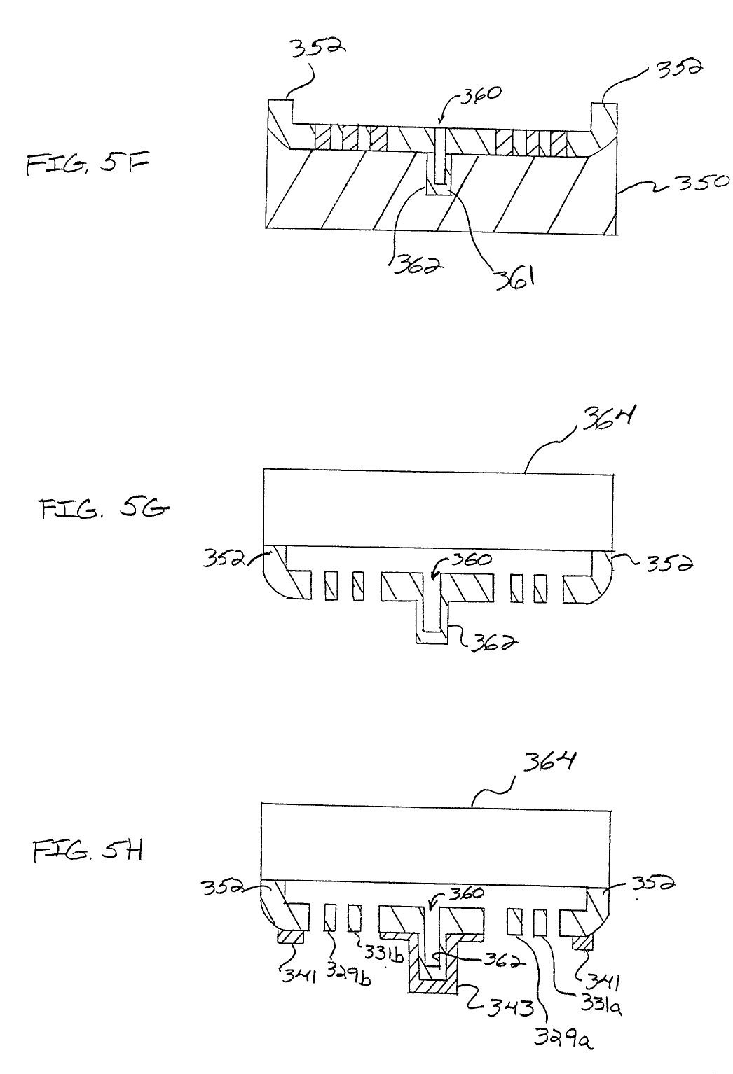

Another embodiment of this invention now will be described in connection with FIGS. 5A-5H. In this embodiment the actuator movable arms 329a, 329b, 331a, 331b and the mirror 327 are formed on the same side of a substrate, which is then attached to a base.

By way of non-limiting example, as shown in FIG. 5A, a silicon wafer 350 can be used as the workpiece from which a mirror body 362, comparable to the mirror core described in previous embodiments, and actuator movable arms 329a, 329b, 331a, 331b are formed. Other materials also could be used as the workpiece, by way of non-limiting example, other semiconductors such as Ge, compound conductors, GaAs and InP. In contrast to embodiments of this invention already described, in the present embodiment the procedures which are carried out to form the mirror body 362 and actuator movable arms 329a, 329b, 331a, 331b are all performed from just one side of the silicon wafer 350, as will now be explained.

First, as depicted in FIG. 5A, a shallow recess 351 is formed on the top side of the silicon wafer 350. This leaves the silicon wafer 350 with shoulder portions 352. The recess 351 can be produced in known manner, for example, by photoresist processing. Generally, in such a process the silicon wafer 350 is selectively coated with photoresist material to protect portions of the substrate not to be removed. Portions of the silicon wafer 350 which are not protected by the photoresist can be removed by known methods such as wet-etching or dry plasma silicon etching, or any other suitable technique, whether now known or hereafter developed. As will be clear from following portions of this disclosure, the recess 351 serves to insure that the mirror body 362 and actuator movable arms 329a, 329b, 331a, 331b all have sufficient clearance to move without restraint when the actuator is operated. As will be explained in greater detail hereafter, the shoulder portions 352 and recess 351 are formed on the opposite side of the substrate 350 than the mirror body 362.

Although the shoulders depicted in FIG. 5A are shown as being integral parts of the substrate 350, the shoulder portions could be formed in other ways. For example, the shoulders could be formed by mounting a rectangular frame on a flat substrate, the frame edges becoming the shoulders. The frame and flat substrate together can be considered as substrate 350. Another way to form the substrate would be by mounting a recessed wafer mounted on a planar substrate, the two components together corresponding to substrate 350. In both of these non-limiting examples it should be understood that the term “mounting” is used in the general sense, and encompasses any suitable technique for interrelating the two components.

Next, as shown in FIG. 5B, a heavily-doped diffusion layer 354 containing a P-type dopant such as boron (P⁺) ions is formed on the exposed upper surface of the silicon substrate 350 (the term “upper” is used only for convenience and not limitation; other orientations could be employed). Although diffusing the heavily-doped boron layer is presently thought to be preferred, alternative techniques such as liquid source doping and ion implantation also could be used. The diffusion layer 354 is processed in a manner which will be discussed hereafter to form the actuator electrodes 329a, 329b, 331a, 331b and the mirror body 362. This way, the actuator electrodes 329a, 329b, 331a, 331b will be the same thickness as the diffusion layer 354. By way of non-limiting example, the P⁺ ions could be diffused into the silicon substrate 350 to a depth of 10 μm. Since the thickness of the diffusion layer 354 is strongly dependent upon the time during, and temperature at, which diffusion takes place, the thickness of the actuator electrodes 329a, 329b, 331a, 331b and the mirror body 362 can be precisely controlled by carefully selecting both of those diffusion parameters. It should be understood that doping profiles different from that shown in FIG. 5B also could be employed, whether thicker, thinner, or of variable thickness. Additionally, more than one dopant material could be used, and different regions of the substrate 350 could be doped with different materials.

Next, the diffusion layer 354 is shaped to define what will become the mirror body 362 (shown in other drawings) and the actuator electrodes 329a, 329b, 331a, 331b. With reference now to FIG. 5C, this can be done first by using photoresist processing in a known manner to apply selectively a protective coating (not shown) atop portions of the diffusion layer 354. Next, portions of the diffusion layer not covered by the protective coating are removed by etching in known fashion. By way of non-limiting example, the unprotected areas could be approximately 1 μm wide, and etching could be performed in known manner by using deep RIE plasma etching to cut gaps 356 extending downward completely through the P⁺ diffusion layer 354. These gaps 356, as shown in later drawings, separate what will become part of the mirror support 362 and adjacent actuator electrodes 329a, 329b, 331a, 331b. RIE etching is presently thought to be preferred because of the high accuracy which it offers.

With reference now to FIG. 5D, the gaps 356 between what will become the mirror support 362 and what will become the adjacent actuator electrodes 329a, 329b, 331a, 331b can be filled at least partially with SiO₂ spacers 358. By way of non-limiting example, these spacers 358 can be provided by thermally oxidizing or performing low-temperature CVD oxide processing on the P⁺ diffusion layer 354. As can be seen in FIG. 5D, this results in a structure having a relatively even upper surface. Again, it should be understood that this step, while preferable, may be omitted or modified, for example, by partially-filling the gaps 356 or only filling some of those gaps.

SiO₂ spacers secure the actuator electrodes 329a, 329b, 331a, 331b and the mirror support 362 in place during the manufacturing process. As will be explained in greater detail below, these spacers 358 are later removed, freeing the actuator electrodes 329a, 329b, 331a, 331b and the mirror support 362.

Next, photoresist processing and a deep RIE plasma etching are performed as depicted in FIG. 5E to create a deep groove 360 at the site of the mirror support 362 extending completely through the P⁺ layer 354 into the underlying portion of the Si wafer 350. By way of non-limiting example, it is presently thought to be preferable to provide groove 360 at the center of the mirror support 362. Also by way of non-limiting example, the groove 360 can be approximately perpendicular to the plane of the Si wafer 350, and approximately 40 μm deep.

With reference now to FIG. 5F, further P⁺ diffusion processing is carried out to form an additional diffusion region 361 extending along the sides and bottom of the deep groove 360 which has been formed in the Si wafer 350. This completes a roughly “T”-shaped mirror support 362, which will become the movable mirror. Optionally, this new diffusion layer 361 can have the same composition and thickness as the diffusion layer that was previously formed on the wafer 350. Alternatively, to improve MEMS assembly performance, some portions of the mirror support 362 could be thinned to reduce the weight of the mirror support 362, and so increase its actuation speed.

The assembly depicted in FIG. 5F is next joined to a base wafer 364. By way of non-limiting example, the base wafer 364 could be made from PYREX® glass, and the joining could be effected by anodic (electrostatic) bonding. The joined wafers 350, 364 are then wet etched in EDP (ethylene diamine/pyrocatechol/water). In known manner, such etching will end at the P⁺ diffusion layer 354, which thereby serves as an etch stop. A further wet etching step is then carried out in known manner under suitable conditions to remove the oxide spacers 358 from between the actuator movable arms 329a, 329b, 331a, 331c and the mirror support 362, resulting in the substrate assembly depicted in FIG. 5G.

Next, a suitable reflective and conductive material such as Au/Cr is patterned using known techniques onto the joined substrates 350, 364. As shown in FIG. 5H, the patterned material deposited on the diffusion layer 354 corresponding to the etched groove 360 forms the mirror 343, and other areas of patterned material define the bond pads 341 which allow an external energy source to drive the mirror 343. While it is presently thought to be preferable to pattern the metallization layer before the spacers are removed, the patterning could be effected after the spacers are removed.

Among the benefits of this embodiment of the present invention are reductions in the cost of fabricating both electrostatic and electrothermal actuators as compared with other fabrication techniques. This invention also allows for fine patterning of electrodes, owing to the small size of gaps, i.e., 1 μm, which can be formed in the diffusion layer of Si material.

Fifth Embodiment

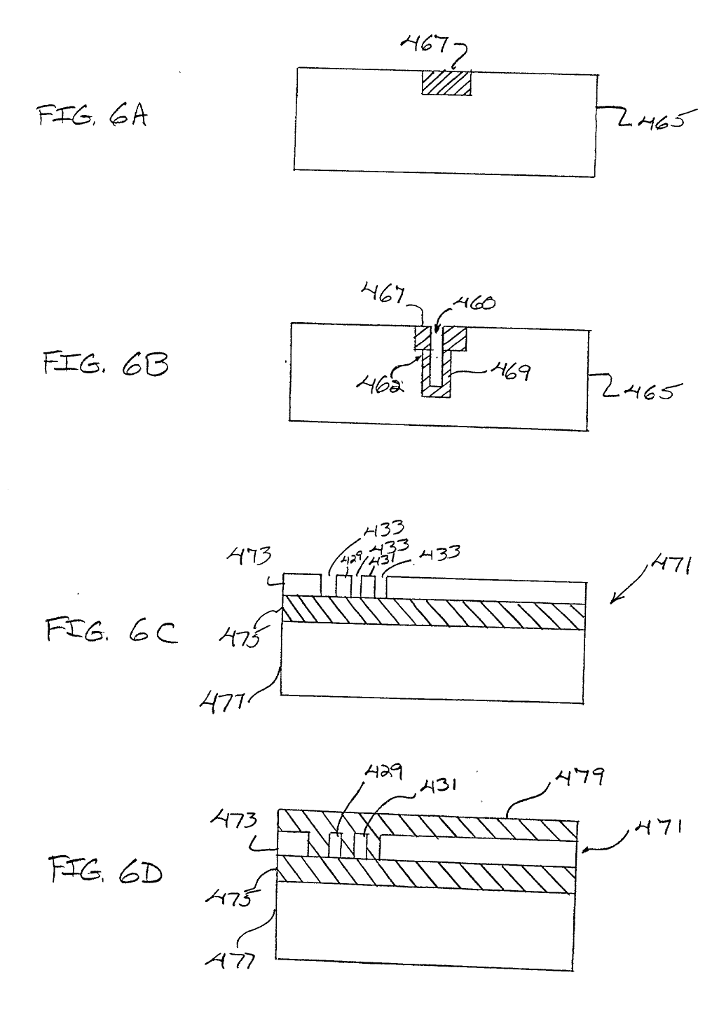

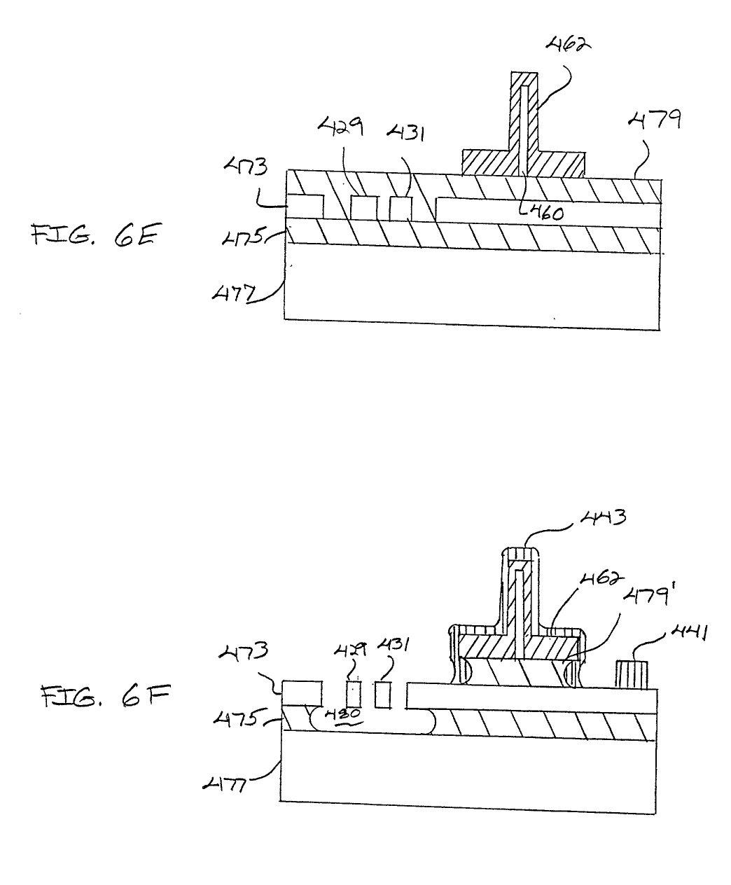

The next embodiment of this invention will be described with reference to FIGS. 6A-6F. In this embodiment the mirror and actuator beams are formed on separate wafers and are then joined together.

As shown in FIG. 6A, a P⁺ diffusion layer 467 approximately 10 μm deep and 100 μm wide is created on the surface of a first silicon wafer 465 from which the MEMS mirror will be formed. The diffusion layer 467 can be formed using known photolithographic techniques. Then, the diffusion layer 467 is masked, selectively coated with suitable photosensitive material, and subject in known fashion to deep RIE silicon plasma etching to form a deep groove 460 therein, as depicted in FIG. 6B. By way of non-limiting example, that groove 460 could be 40 μm deep. The groove 460 is then subject to additional P⁺ diffusion to form a further diffusion region 469 on the sides and bottom of the groove 460 in the manner already described in connection with the previous embodiment. The resulting diffusion regions 467 and 469, as depicted in FIG. 6B, together form a mirror support 462 which can by way of non-limiting example be roughly “T”-shaped in cross-section. As will be explained in greater detail hereafter, this T-shaped mirror support 462 serves as the core of the MEMS mirror.

The electrodes 429, 431 which actuate the MEMS mirror are formed on a second substrate 471. The second substrate 471 has a multilayer construction consisting of a SiO₂ layer 475 sandwiched between upper and lower Si layers 473, 477 . To create the electrodes 429, 431, the upper surface of the layered Si-oxide-Si substrate 471 is patterned and etched so that several grooves 433 each about 20 μm deep extend downward through the upper Si layer 473 to expose the central oxide layer 475, as shown in FIG. 6C. These grooves 433 thereby define the several actuator electrodes 429, 431. By way of non-limiting example, the patterned Si layer 473 undergoes a deep RIE etch to a depth of 20 μm. Thus, it will be appreciated that the actuator movable arms can be formed in the same manner as has been described previously with regard to the first embodiment of this invention.

Next, as shown in FIG. 6D, the second wafer 471 is thermally oxidized. This fills the grooves 433 which were formed in the upper silicon layer 473 with SiO₂, and provides a level top surface. While it is presently thought to be preferable to fill the grooves substantially completely, this is not necessary; grooves could be filled partially, and different grooves could be filled with different amounts of material.

With reference now to FIG. 6E, the first and second substrates 465, 471 have been suitably oriented and positioned so that the base of the T-shaped mirror core 462 sits atop the oxide layer 479 formed on the second substrate 471. The two substrates 465, 471 are joined together, affixing the base of the inverted T-shaped mirror core 472 to the underlying oxide layer 479. By way of non-limiting example, the substrates 465 and 471 could be connected by fusion bonding.

Next, the workpiece consisting of the joined substrates 465, 471 is etched, preferably with EDP (ethylene diamine/pyrocatechol/water) or TMAH or KOH, to selectively remove silicon, but not the P⁺ diffusion layer 475. All of the first substrate 465, save for the inverted T-shaped mirror core 472 made from the diffusion layer material, is thereby removed. This results in the arrangement depicted in FIG. 6F, wherein the head of a the T-shaped mirror core 472 rests atop a pedestal of oxide material 479′, which in turn rests upon the upper silicon layer 473 of the second substrate 471.

Next, the workpiece is wet etched to remove unwanted portions of the sandwiched oxide layer 475 that is part of the second substrate 471. As can be seen in FIG. 6F, all of the oxide 479 which had been lying atop the Si layer 473, as well as the oxide material present between the actuator electrodes 429, 431, is removed. The etching is controlled by the selectivity of the etchant with respect to the silicon material so that the portion 480 of the oxide layer 475 underlying those actuator electrodes 429, 431 and above Si layer 477 is removed without significantly undercutting the overlying Si layer 473.

The MEMS mirror's reflective coating 443, bond pads 441 and interconnects for the actuator electrodes (not shown) are formed by applying Au/Cr material in known fashion, by way of non-limiting example, using photoresist patterning technology.

Among the benefits of constructing a MEMS actuator in this manner are complete separation of the procedures for forming the mirror and the actuator electrodes.

Another advantage to constructing a MEMS actuator as just explained is that the size of the mirror and the actuator electrodes can be controlled with a high degree of precision, owing to the procedures which are used to form those structures.

Sixth Embodiment

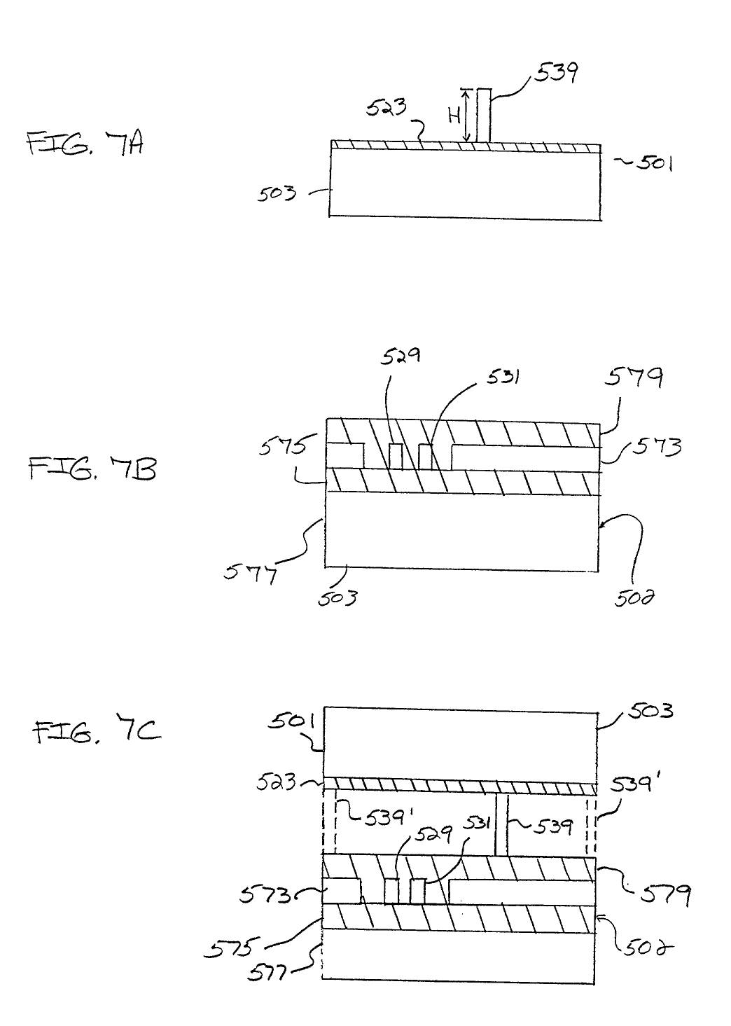

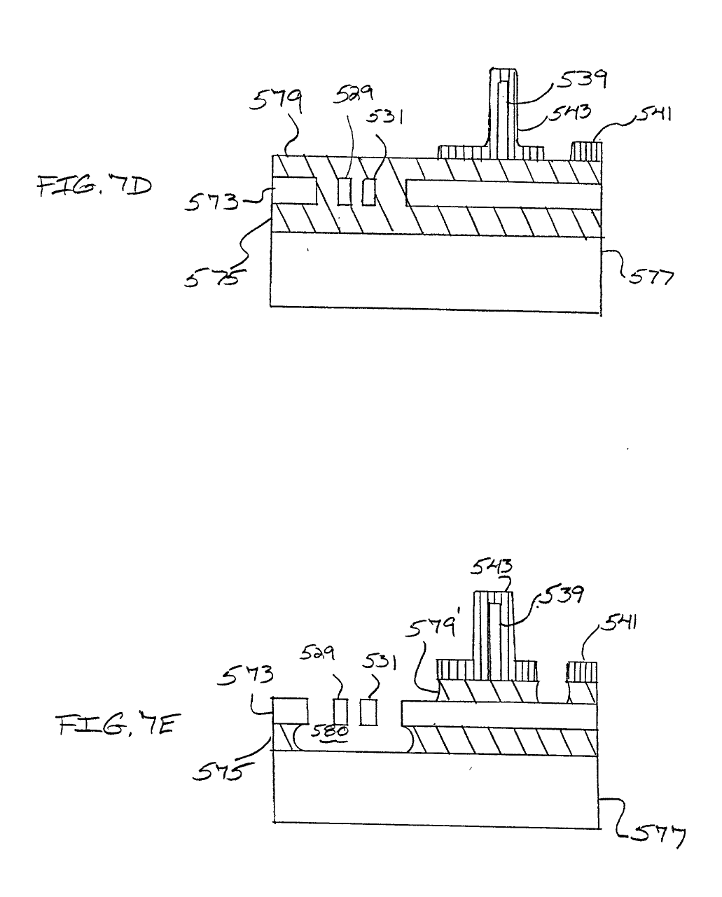

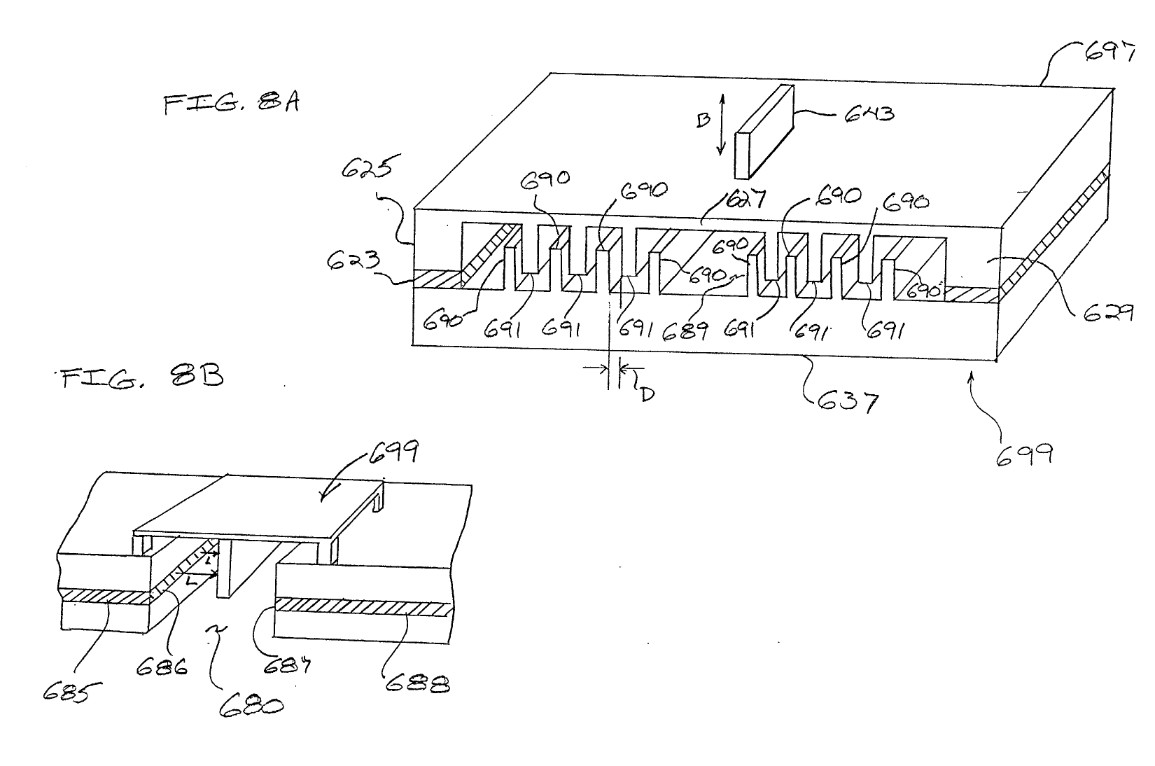

FIGS. 7A-7E depict another embodiment of this invention in which the mirror core and the actuator electrodes are formed on separate substrates. In this embodiment, a first substrate 501 having a mirror core 539 formed thereon, by way of example, using procedures such as those described above in connection with previous embodiments of this invention, is attached to a second supporting substrate 502 having actuator electrodes 529, 531.

This embodiment is thought to be particularly advantageous for use in constructing devices having high aspect ratio mirrors. Such mirrors can be fragile and therefore processing and handling MEMS devices using those mirrors can be difficult, in particular, when multiple devices formed on a single substrate are separated by dicing the substrate. This embodiment facilitates handling of the different device components by forming the components on two different wafers. This allows the wafers to be diced and processed without having to protect the mirrors.

The first substrate 501 can be made from a SOI wafer having a silicon layer 503 supporting an oxide layer 523. As will be explained in detail hereafter, this oxide layer 523 serves as a stop layer in generally the same manner as already has been described in connection with other embodiments of this invention. Selective photoresist patterning of a protective layer atop an overlying silicon layer (not shown), followed by a deep RIE etch of that overlying silicon layer ending when the oxide stop layer 523 is exposed, is carried out to form a rectangular mirror core 539 the height H of which is the same as or less than the thickness of the active layer, depending upon the REI etch conditions.

As will be explained in greater detail below with reference to FIG. 7C, at least one dummy mirror core 539′ could be formed at the same time and in like manner as mirror core 539. These dummy mirror cores may differ in width from mirror core 539.

The second substrate 502 has silicon layers 573, 577 sandwiching an oxide layer 575. In a manner similar to that just described with regard to the previous embodiment, the actuator electrodes 529, 531 which will drive the MEMS mirror are formed by selectively removing portions of the upper Si layer 573 of the second silicon wafer 502, as shown in FIG. 7B, to form the actuator electrodes 529, 531. The height H of actuator electrodes 529, 531 is the same as the thickness of the upper silicon layer 573. By way of non-limiting example, the upper silicon layer 573 could be removed by subjecting the silicon layer 573 to a deep RIE etch, say, to a depth of 20 μm.

In the same manner as was earlier described, the second wafer 502 is thermally oxidized to fill in with SiO₂ material the gaps created between the electrodes 529, 531 in the upper silicon layer 573, and to create an oxide layer 579 above the upper silicon layer 573, as can be seen in FIG. 7B. Other fabrication techniques also could be used.

Next, the first and second substrates 501, 502 are arranged so that the mirror core 539 of the first substrate 501 faces the oxide layer 579 formed on the upper silicon layer 573 of the second substrate 502, as depicted in FIG. 7C. Optionally, at least one dummy mirror core 539′, which may be formed in the same manner and at the same time as the mirror core, and which is preferably the same height as the mirror core 539, can be provided to support and further stabilize the two substrates 501, 502 as they are brought together (the dummy mirror core 539′ will be removed before the workpiece is complete). The two substrates 501, 502 are then joined, for example, by silicon direct bonding, also known as fusion bonding, which affixes the mirror core 539 and the dummy mirror core(s) 539′ formed on the first substrate 501 to the oxide layer 579 which overlies the upper silicon layer 573 of the second substrate 501.

Then, all of the first substrate 501 save for the mirror core 539 is removed. By way of non-limiting example, the first substrate 501 can be wet-etched, with etching stopping at the mirror core 539 and the underlying oxide layer 579. Alternatively, the Si and oxide layers 503, 523 of the first substrate 501 could be removed by wet etching, while the remaining dummy mirror(s) 539′ could be removed by cutting, whether in a separate cutting step or as part of a dicing process which can be used to separate multiple components which are formed on a single substrate.

The mirror core 539 is then coated with reflective material such as Au/Cr in a suitable metallization process, such as any of those processes which already have been described. At the same time, any necessary bond pads 541 or other contact or conductor structures can be formed. The results in formation of a mirror 543 having the shape of an inverted “T” atop the oxide layer 579 which lies beneath the mirror core 539, and atop the upper Si layer 573 of the second substrate 502.

Next, unwanted portions of the oxide layer 579 lying atop the upper Si layer 573 of the second substrate 502 can be removed by further wet-etching, as depicted in FIG. 7E. This removes all of the exposed oxide layer 579 lying atop the upper silicon layer 573 of the second substrate 502, as well as the regions of oxide formed between the actuator electrodes 529, 531. Also in known manner, the wet etching is controlled so that just the endmost portions of the oxide layer 573 disposed beneath the T-shaped mirror 543 are removed, leaving a cavity 580 beneath the actuator electrodes 529, 531. Thus, the T-shaped mirror 543 sits atop a pedestal of oxide material 579′, which in turn rests on the upper silicon layer 573 of the second substrate 502.

Among the benefits offered by the foregoing aspects of this invention are that the heights of both the mirror and the actuators can be controlled with great precision by using the oxide layer as an etch stop.

Another benefit to this embodiment is that it simplifies the fabrication process.

As with the foregoing embodiment, constructing a MEMS actuator in accordance with this embodiment separates the procedures used to form the mirror and the actuator electrodes.

An electrostatically-actuated planar MEMS assembly in which the MEMS mirror can be moved in a direction perpendicular to the plane of the actuator can be constructed as described above. As depicted in FIG. 8A, the MEMS assembly 699, consisting of a mirror 643 and actuator 697, includes a generally planar silicon base 637 and covering silicon diaphragm 625. The silicon base 637 and silicon diaphragm 625 are separated by and are each joined to an oxide layer 623. The actuator 697 is constructed such that the MEMS mirror 643 can be moved in the direction of arrow B.

MEMS mirror 643 is formed atop the silicon diaphragm 625 as described above, and as shown by way of non-limiting example in FIGS. 8A and 8B, can be rectangular in shape.

The generally planar silicon base 637 is approximately 2 mm wide, 2 mm deep, and 400 μm thick. A set of eight ridges 690 each approximately 50 μm high and 4 μm wide protrude upward from the planar silicon base 637. As depicted in FIG. 8A, these ridges 690 are preferably perpendicular to the plane of the base. By way of non-limiting example, ridges 691 can be arranged in two groups of four about a central region 689. Other numbers of ridges, ridges of different shape, and different ridge groupings also could be used.

The covering silicon diaphragm 625 is approximately 2 mm wide, 2 μm deep, and 400 μm thick. The roof 627 of the covering silicon diaphragm 625 can be approximately 10 μm thick, with an enlarged rim portion 629 approximately 100 μm wide and 400 μm thick running along the diaphragm's edge. The enlarged rim portion 629 helps to stiffen the covering diaphragm 625. Enlarged rim portion 629 is joined to the base 637 by an oxide layer 623 therebetween. The oxide layer 623 is by way of non-limiting example approximately 1 μm thick, and as depicted in FIG. 8A, lies completely between the enlarged rim portion 629 of the covering diaphragm and the base 637. This arrangement of the oxide layer 623 is by way of illustration only, and not limitation, and other configurations, such as an intermittent oxide layer or multiple layers, also could be used.

With continued reference to FIG. 8A, a set of six ridges 691 approximately 50 μm high and 4 μm wide protrude downward from the covering diaphragm 625; other numbers of ridges, and ridges of different shape also could be used. As depicted in FIG.8A, these ridges 691 are preferably perpendicular to the plane of the base 637. These ridges 691 are arranged in two groups of three about central region 689, and these ridges 691 interlace in alternation with the ridges 690 formed in the base 637. Again, other numbers and groupings of ridges can be utilized.

With continued reference to FIG. 8A, the MEMS mirror 643 is preferably disposed at the center of the covering diaphragm 625. As depicted in FIG. 8A, the plane of the MEMS mirror 643 is preferably perpendicular to the plane of the covering diaphragm 625.

As depicted in FIG.8A, the ridges 690 of the planar silicon base 637 and the ridges 691 of the covering silicon diaphragm 625 are arranged in registry and dimensioned so that the tips of the two different sets of ridges 690, 691 are interlaced in alternation. It should be understand that while the depicted alternating arrangement of ridge tips is thought to be preferable, that arrangement is only by way of example and not limitation, and that other arrangements also could be used. It also should be noted that since the rim portion 629 and the ridges 691 protruding from the roof 627 have the same length from tip to base, the ends of those ridges 691 are clear of and separated from the facing portions of the base 637 by the thickness of the oxide layer 623. Again, it should be understood that this arrangement is by way of non-limiting example, and that the ridges 691 and rim portion 629 of the covering diaphragm 625 need not be the same thickness. The ridges 690 need not all be the same length. Nor need all of the ridges 691 be the same length.

Nor need the ridges be arranged symmetrically. As shown in FIG. 8A, adjacent ridges 690, 691 are separated from one another by distance D, which, by way of non-limiting example, could be approximately 1 μm. As an alternative, some or all of the ridges 690, 691 could be separated from one another by varying distances. Likewise, the depiction of three sets of ridges 691 for the diaphragm and four sets of ridges 690 for the base 637 is by way of non-limiting illustration, and any other number of ridges also could be used.

As depicted in FIG. 8A, the two sets of ridges 690, 691 are preferably straight and parallel to one another. Other ridge configurations, such as “V”, curved or serpentine shapes, also could be used.

The MEMS assembly 699 can be driven electrostatically. Applying voltage to the covering diaphragm 625 and the base 637 will produce an attractive force therebetween, owing to the opposite charges which accumulate at the tips of ridges 691 and 692. The thickness of the covering diaphragm 625 is such that the covering diaphragm 625 can flex and move toward the base 637 as a consequence of the attractive force; by way of non-limiting example, the application of approximately a 100 volt potential between the covering diaphragm 625 and the base 637 should cause the covering diaphragm 625 in the vicinity of mirror 643 to move toward the base 637 by about 25 μm. Movement of the covering diaphragm 625 will also move the MEMS mirror 643 thereon; the position assumed by the mirror 643 when electrical potential is applied to the actuator is referred to as the driven position, in contrast to the rest position, which is the position assumed by the mirror when no potential is applied to the actuator. Consequently, the MEMS mirror 643 can be reciprocally shifted in the direction of arrow B through the application and removal of electrical potential to the covering diaphragm 625 and base 637.

A MEMS assembly 699′ in accordance with this invention can be used to control the passage of light in an optical data system. In such a system, as depicted in FIG. 8B, light travels through a first waveguide 685, leaves that first waveguide 685 through a first facet 686, passes across a trench 680, enters a second waveguide 688 through a second facet 687, and travels along the second waveguide 688. By way of non-limiting example, each waveguide 685, 688 can be a silica waveguide having a core surrounded by cladding.

This embodiment can be employed with a wide variety of waveguide systems, such as Ge, GaAs and InP.

Among the benefits of this MEMS assembly is that the actuator always assumes a specific position when power is not applied. That is, the MEMS assembly will only maintain the mirror 643 in the driven position while voltage is applied thereto. This means that a system using this MEMS actuator can be designed keeping in mind the configuration that would result if power is lost, causing all of the MEMS actuators to shift to the rest position.

This invention can be used in either a 1×1 or a 1×2 switch. In the 1×1 switch, light L traveling across the trench 680 can be controlled by placing the movable shutter 643 in the light's path; depending upon the position of shutter 643, light will or will not enter the output waveguide. If the shutter 643 is positioned in the path of the optical signal leaving facet 686, light leaving that first facet 686 will strike shutter and be blocked from entering the facet 687 of the output waveguide 688.

In the 1×2 switch, light L traveling across the trench 680 can be controlled by placing the movable mirror 643 in the light's path of light; depending upon the position of mirror 643, light will enter one of two different output waveguides. If the mirror 643 is positioned in the path of the optical signal leaving facet 686, light leaving that first facet 686 will strike mirror 643 and be guided into a third facet (not shown) of a third waveguide (not shown).

Among the benefits of this embodiment is that the mirror (or shutter) used requires less space than is needed for mirrors (or shutters) used in conventional devices that move the mirror (shutter) in the same plane as the waveguides. In addition, the mirror or shutter used in the present invention can be smaller than a conventional lateral motion mirror.

Given the reduced size of the mirror or shutter which can be used with this invention, and the reduced amount by which such a mirror or shutter need be moved, an optical switch constructed in accordance with the present invention will have a faster response time than conventional switches.

It should be noted that another virtue of this invention is that the MEMS mirror, owing to the inherent properties of the covering diaphragm, always assumes the upward position furthest from the base when the electrical potential is removed. Thus, another benefit of this invention is that it can be incorporated into optical devices to provide optical systems which automatically assume a known state in the absence of electrical power.

Also by way of example, the present MEMS mirror and actuator can be used as an attenuator. In such an attenuator the position of the mirror can be calibrated as a function of electrode capacitance. The construction of such attenuators need not be described herein, since various types of attenuators such as Mach-Zehnder and Fabry-Perot devices are known.

By way of non-limiting example, a MEMS mirror and actuator in accordance with this embodiment can preferably be prepared in part by using the fabrication method described in the second embodiment of this invention to produce the ridged covering diaphragm. With reference now to FIG. 3A, this can be done by modifying the fabrication method so that grooves 133 are provided in a number and arrangement sufficient also to define ridges 690, 691. As with the second embodiment of this invention, sufficient silicon 140 is left between all the grooves 133 and the underlying oxide layer 123 to form the ceiling of the covering diaphragm, while not leaving so much silicon 140 that the ceiling is too stiff. If desired, other fabrication methods such as the first and other embodiments of this invention also could be used.

The ridged base plate can be formed separately by coating, masking and etching the base plate 137 the same manner as already has been described in connection with forming grooves in the lower silicon wafers of the first and second embodiments of this invention, as well as by using any suitable techniques which may be developed hereafter.

To join the covering diaphragm and the supporting substrate together the covering diaphragm can by way of non-limiting example be attached by anodic (electrostatic) bonding to the supporting substrate in the manner already disclosed. As one example of an alternative bonding technique, the covering diaphragm and the supporting substrate could be joined together by forming a low temperature glass frit seal therebetween.

Other methods disclosed herein also may be suitable for fabricating devices in accordance with this invention. Furthermore, known methods and methods developed hereafter also may be employed to manufacture a MEMS assembly covered by this invention.

It should be understood that the dimensions and orientation of the MEMS assembly and directions such as “up” and “down” used in connection with this invention are by way of non-limiting example; other orientations and arrangements also could be used.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

What is claimed is:

1. A method of manufacturing a MEMS assembly having a mirror and an actuator, comprising the steps of:
providing a first substrate and a second substrate having a recess;
forming a plurality of grooves in a first side of the first substrate, the grooves being dimensioned and disposed so as to define a plurality of electrode actuators and a central mass therebetween, wherein the plural electrode actuators and the central mass are attached to a portion of the first substrate;
joining the first substrate and the second substrate together so that the grooves are in registry with the recess;
forming the displaceable member on a second side of the first substrate, the second side being opposite to the first side; and
removing the portion of the first substrate to which the electrode actuators are attached.

2. A method according to claim 1, wherein the first substrate is a single layer of silicon.

3. A method according to claim 1, wherein the first substrate includes an etch stop layer of a predetermined thickness, the etch stop layer being sandwiched between an upper layer of silicon and a lower layer of silicon.

4. A method according to claim 3, wherein the etch stop layer includes SiO₂.

5. A method according to claim 3, wherein the step of forming the grooves comprises etching the first substrate to the etch stop layer to form at least one of said grooves.

6. A method according to claim 1, further comprising the step of applying metallization to the member to form a mirror.

7. A method according to claim 1, further comprising the step of removing part of the second surface of the substrate to form the displaceable member.

8. A method according to claim 5, further comprising the step of etching the substrate in the direction of the etch stop layer to a predetermined distance from the etch stop layer.

9. A method according to claim 1, wherein at least one of the steps of forming the plurality of grooves, forming the displaceable member and removing the portion of the first substrate includes at least one of plasma etching, dry plasma etching, deep RIE plasma etching, wet etching, ultrasonic machining and EDM.

10. A method of manufacturing a MEMS assembly having a displaceable member and an actuator, comprising the steps of:
providing a first substrate having at least two shoulders and a surface;
forming an actuator assembly by;
diffusing impurities into the surface of the substrate to form a diffusion layer having a predetermined thickness;
etching a plurality of first grooves in the diffusion layer, the grooves being dimensioned and disposed so as to define in the diffusion layer portions corresponding to a plurality of electrode actuators and the displaceable member therebetween;
filling at least some of the grooves with a spacer material;
forming a second groove in the portion of the diffusion layer corresponding to the displaceable member, the second groove extending through the thickness of the diffusion layer to expose a region of the underlying first substrate; and
diffusing impurities into at least part of the exposed region of the first substrate to form a diffusion region;
removing the spacer material from the first grooves, whereby the plural electrode actuators and the mirror body are freed, to obtain an actuator assembly.

11. A method according to claim 10, further comprising the step of applying metallization to at least the mirror body.

12. A method according to claim 10, wherein at least one of the steps of etching the first grooves, forming the second groove and removing the spacer material includes at least one of plasma etching, dry plasma etching, deep RIE plasma etching, wet etching, ultrasonic machining and EDM.

13. A method according to claim 10, wherein the impurities include boron.

14. A method of manufacturing a MEMS assembly according to claim 10, wherein the two shoulders of the first substrate are formed by a frame mounted on a planar substrate.

15. A method of manufacturing a MEMS assembly according to claim 10, wherein the two shoulders of the first substrate are formed by a recessed wafer mounted on a planar substrate.

16. A method of manufacturing a MEMS assembly according to claim 10, further comprising the steps of:
providing a second substrate; and
joining the actuator assembly and the second substrate.

17. A method of manufacturing a MEMS assembly according to claim 10, wherein the actuator assembly and the second substrate are joined before the removing of the spacer material.

18. A method of manufacturing a MEMS assembly having a displaceable member and an actuator, comprising the steps of:
providing a first substrate having a surface;
diffusing impurities into the surface of the first substrate to form a first diffusion region having a predetermined thickness;
forming a groove in the first diffusion region, the groove extending through the thickness of the diffusion region to expose a portion of the first substrate lying therebeneath;
diffusing impurities into the groove to form a second diffusion region, the first and second diffusion regions together forming the displaceable member;
providing a second substrate having an upper layer, a lower layer, and a layer of oxide sandwiched between the upper layer and the lower layer;
etching the upper layer toward the oxide layer at spaced intervals to form a plurality of grooves in the upper layer of the second substrate, the grooves being dimensioned and disposed so as to define a plurality of electrode actuators, wherein the plural electrode actuators remain attached to a portion of the oxide layer;
covering at least a portion of the upper layer with a covering oxide layer, the covering oxide layer at least partially filling the grooves located in the portion of the upper layer;
placing the first substrate and the second substrate together such that the first diffusion region contacts at least a portion of the covering oxide layer; and
removing some of the covering oxide layer, including the oxide layer filling the grooves, at least some of the oxide layer remaining beneath and supporting the first diffusion region, whereby the plural electrode actuators are freed.

19. A method according to claim 18, further comprising the step of applying metallization to at least part of the displaceable member to form a mirror.

20. A method according to claim 18, wherein at least one of the steps of forming the grooves in the first diffusion region, etching the upper layer, and removing some of the covering oxide layer includes at least one of plasma etching, dry plasma etching, deep RIE plasma etching, wet etching, ultrasonic machining and EDM.

21. A method according to claim 18, wherein the impurities include boron.

22. A method according to claim 18, wherein the oxide layer includes SiO₂.

23. A method of manufacturing a MEMS assembly having a displaceable member and an actuator, comprising the steps of:
providing a first substrate having a lower layer, a first oxide layer and the displaceable member extending from the oxide layer and lying in a plane which is not parallel to a plane of the first substrate;
providing a second substrate having an upper layer, a lower layer and a second oxide layer being sandwiched between the upper layer and the lower layer;
forming a plurality of grooves in the upper layer of the second substrate, the grooves being dimensioned and disposed so as to define a plurality of electrode actuators attached to a portion of the second oxide layer;
covering at least a portion of the upper layer with a covering oxide layer so as to fill the grooves formed in the upper layer;
placing the first substrate and the second substrate together such that the displaceable member contacts part of the covering oxide layer;
removing the lower layer of the first substrate and the first oxide layer; and
etching the covering oxide layer in an area apart from the displaceable member, including the oxide layer filling the grooves, wherein at least some of the second oxide layer remains beneath and supports the upper layer of the second substrate, whereby the plural electrode actuators are freed.

24. A method according to claim 23, further comprising the step of applying metallization to at least part of the displaceable member.

25. A method according to claim 23, wherein at least one of the steps of forming the grooves in the upper layer of the second substrate, removing the lower layer of the first substrate and the first oxide layer, and etching the covering oxide layer includes at least one of plasma etching, dry plasma etching, deep RIE plasma etching, wet etching, ultrasonic machining and EDM.

26. A method of manufacturing a MEMs assembly according to claim 23, further comprising the step of providing the first substrate with at least one dummy member extending from said first oxide layer, parallel to and spaced apart from the displaceable member, thereby stabilizing the first and the second substrates as they are placed together.

27. A method of manufacturing a MEMS assembly according to claim 26, further comprising the step of removing the dummy member and then applying metallization to the displaceable member.

28. A MEMS assembly, comprising:
a generally planar silicon base having a plurality of ridges extending therefrom;
a generally planar covering silicon diaphragm joined to the silicon base and a plurality of ridges extending from one surface of a roof portion; the ridges of the silicon diaphragm interlacing with at least some of the ridges of the silicon base;
a member disposed on a second surface of the roof portion of the silicon diaphragm, the second surface being on an opposite side of the silicon diaphragm from the plurality of ridges,
whereby when an electrical potential is applied to the silicon base and the silicon diaphragm, the silicon base and the silicon diaphragm move toward one another.

29. A MEMS assembly according to claim 28, further comprising a rim portion at least partially enclosing the roof portion.

30. A MEMS assembly according to claim 29, wherein the rim portion is formed by a frame.

31. A MEMS assembly according to claim 29, wherein the rim portion is formed from a recessed substrate.

32. A MEMS assembly according to claim 28, wherein the ridges of the silicon base are generally perpendicular to the silicon base, and the ridges of the silicon diaphragm are generally perpendicular to the silicon diaphragm.

33. A MEMS assembly according to claim 28, wherein the ridges of the silicon base and the ridges of the silicon diaphragm are both arranged symmetrically about a central region, and the displaceable member is located adjacent to the central region.

34. A MEMS assembly according to claim 28, wherein when an electrical potential is applied to the silicon base and the silicon diaphragm, the displaceable member moves in a direction generally perpendicular to a plane in which the silicon base and the silicon diaphragm lie.

35. A MEMS assembly according to claim 29, further comprising an oxide layer disposed between the rim portion and a corresponding portion of the silicon base.
